(19) United States
(12) Patent Application Publication
(10) Pub. No.: US 2022/0263146 A1
(43) Pub. Date: Aug. 18, 2022

(54) PROCESS FOR CRUSHING AN ELECTROCHEMICAL GENERATOR

(71) Applicant: COMMISSARIAT À L'ÉNERGIE ATOMIQUE ET AUX ÉNERGIES ALTERNATIVES, Paris (FR)

(72) Inventor: Emmanuel BILLY, Grenoble (FR)

(21) Appl. No.: 17/595,248

(22) PCT Filed: May 12, 2020
(86) PCT No.: PCT/EP2020/063203

§ 371 Date: Nov. 12, 2021

(30) Foreign Application Priority Data
May 15, 2019 (FR) FR1905066

(51) Int. Cl. H01M 10/54; H01M 10/0525; C22B 1/00; C22B 7/00; C22B 26/12

(52) U.S. Cl. CPC H01M 10/54; H01M 10/0525; C22B 26/12; C22B 7/006; C22B 1/005

(57) ABSTRACT

A process for crushing an electrochemical generator comprising a negative electrode containing lithium or sodium and a positive electrode, the method comprising a step, in which the electrochemical generator is crushed in an ionic liquid solution comprising an ionic liquid and a so-called oxidizing redox species that can be reduced on the negative electrode so as to discharge the electrochemical generator.

### TECHNICAL FIELD

The present invention relates to a process for crushing an electrochemical generator, such as a Li-Ion, Na-Ion, or Lithium-metal accumulator or battery, in particular with a view to the recycling and/or storage thereof.

More specifically, the invention relates to a method in which an electrochemical generator is crushed in a solution containing an ionic liquid and a redox-active species. The redox-active species is used to discharge the electrochemical generator. The ionic liquid allows this step to be carried out in complete safety, in particular by preventing the formation of an explosive atmosphere.

The recoverable fractions of the electrochemical generator can then be safely recycled.

### PRIOR ART

An electrochemical generator is a power generation device that converts chemical energy into electrical energy. This can, for example, be battery cells or accumulators.

The accumulator market, and in particular that of lithium accumulators of the Li-ion type, is currently expanding rapidly, on the one hand because of so-called portable applications (smartphones, computers, cameras, etc.) and, on the other hand because of new mobility-related applications (electric and hybrid vehicles) and so-called stationary applications (connected to the power grid).

Due to the growth in the number of accumulators in recent years, the issue of recycling them has become a major challenge.

Conventionally, a lithium-ion accumulator comprises an anode, a cathode, a separator, an electrolyte and a casing.

Typically, the anode is formed from graphite mixed with a PVDF-type binder deposited on a copper foil and the cathode is a lithium metal insert material (for example LiCoO₂, LiMnO₂, LiNiO₂, Li₃NiMnCoO₆, or LiFePO₄) mixed with a binder and deposited on an aluminium foil.

The electrolyte is a mixture of non-aqueous solvents and lithium salts, and optionally additives to slow down secondary reactions.

It operates as follows: when charging, the lithium de-intercalates from the metal oxide and intercalates into the graphite, where it is thermodynamically unstable. When discharging, the process is reversed and the lithium ions are intercalated into the lithium metal oxide.

As the cell is used, ageing causes it to lose capacity and it must be recycled.

However, a large number of accumulators or battery packs to be recycled are still at least partially charged and the crushing thereof produces sparks and significant ignitions or even explosions, in particular with primary lithium battery cells (Li—SOCl₂).

Damaged cells must also be recycled. However, these cells can have lithium metal deposits on the anode, which, when exposed to air or water, are highly reactive.

End-of-life and/or damaged cells to be recycled must thus be treated with the utmost care.

The accumulator recycling method comprises a plurality of steps:

a pre-treatment step including a dismantling phase and a making safe phase,

thermal and/or hydrometallurgical treatments to recover the various materials and transformable metals contained in these battery cells and accumulators.

To date, the main difficulty lies in the phase for making these lithium-based (primary and secondary) electrochemical systems safe.

More specifically, when a loss of containment occurs, the electrolyte, a toxic, flammable and corrosive product, leaks out in liquid as well as gaseous form. The vapours thus generated and mixed with air can then form an explosive atmosphere (ATEX). This atmosphere is capable of igniting on contact with a source of ignition such as a spark or a hot surface. This results in an explosion with both thermal effects and pressure effects. Moreover, the electrolyte salts such as lithium hexafluorophosphate LiPF₆, lithium tetrafluoroborate LiBF₄, lithium perchlorate LiClO₄, and lithium hexafluoroarsenate LiAsF₆ can give off particularly toxic and corrosive fumes containing phosphorus, fluorine and/or lithium. For example, hydrofluoric acid (HF) can be formed during the thermal decomposition of Li-ion batteries.

To overcome these drawbacks, the batteries can be crushed in a chamber with a controlled atmosphere and under a controlled pressure. By way of example, the document WO 2005/101564 A1 describes a method for recycling a lithium anode battery by hydrometallurgical means, at ambient temperature and in an inert atmosphere. The atmosphere contains argon and/or carbon dioxide. The two gases will expel the oxygen and form a protective gas space above the crushed charge. The presence of carbon dioxide will cause passivation of the lithium metal by the formation of lithium carbonate at the surface, which slows down the reactivity of this metal. The hydrolysis of the lithium-containing crushed charge leads to the formation of hydrogen. To prevent any risk of hydrogen ignition and explosion, the lithium-containing crushed charge is added in a carefully controlled manner to the aqueous solution and a very strong turbulence is created above the bath. This operation is associated with a depletion of oxygen in the atmosphere. The water becomes rich in lithium hydroxide and the lithium is recovered by adding sodium carbonate or phosphoric acid.

In the method described in the U.S. Pat. No. 5,888,463, the battery cells and accumulators are made safe using a cryogenic method. The battery cells and accumulators are frozen in liquid nitrogen at −196° C. before being crushed. The crushed material is then immersed in water. To prevent any formation of H₂S, the pH is maintained at a pH of at least 10 by adding LiOH. The lithium salts formed (Li₂SO₄, LiCl) are precipitated as a carbonate by adding sodium carbonate.

The document CA 2 313 173 A1 describes a method for recycling lithium-ion battery cells. The battery cells are cut open beforehand in a waterless, inert atmosphere. A first organic solvent (acetonitrile) is used to dissolve the electrolyte and a second organic solvent (NMP) is used to dissolve the binder. The particulate insert material is then separated from the solution and reduced by electrolysis.

In the document WO 2011/113860 A1, a so-called dry technology is described. The temperature of the mill is maintained between 40 and 50° C. and the mixture of hydrogen and oxygen, released from the batteries, is eliminated, by a cyclonic air movement, in order to minimise the risks of a fire. The pieces of battery and dust, recovered after screening, are cooled to ambient temperature. The extraction of lithium appears to take place by reaction with the oxygen and moisture in the air, resulting in risks associated with the simultaneous presence of hydrogen, oxygen and heat that can lead to combustion and explosion. Moreover, the electrolyte is decomposed, leading to risks, losses and difficulties in managing the dust and gases.

The UmiCore VAL'EAS™ method, described in the article by Georgi-Maschler et al. (“Development of a recycling process for Li-ion batteries”, Journal of Power Sources 207 (2012) 173-182) combines pyrometallurgical and hydrometallurgical treatments. The dismantled batteries are fed directly into a furnace. Pyrometallurgical treatment is used to deactivate them: the electrolyte evaporates at around 300° C.; the plastics are pyrolised at 700° C. and the remainder is finally melted and reduced at 1,200-1,450° C. Some of the organic material contained in the battery cells acts as a reducing agent in this method. The aluminium and lithium are lost. The iron, copper and manganese are recovered in an aqueous solution. The cobalt and nickel are recovered as LiCoO₂ and Ni(OH)₂ and recycled to form cathode materials. However, this type of heat treatment consumes a large amount of energy and causes significant decomposition of the battery components.

The document EP 0 613 198 A1 describes a method for recovering materials from lithium battery cells. The battery cells are cut open either under a high-pressure water jet or in an inert atmosphere to prevent a fire. The lithium then reacts with water, an alcohol or acid to form lithium hydroxide, a lithium alkoxide or a lithium salt (for example LiCl) respectively. However, making the process safe by cutting using a high-pressure water jet consumes a large amount of water and generates H₂ gases in air.

To date, the various methods described hereinabove require high-temperature treatments, cryogenic treatments, and/or treatments in a controlled atmosphere, which are conditions that are difficult to industrialise and/or which are expensive.

### DESCRIPTION OF THE INVENTION

One purpose of the present invention is to provide a method for overcoming the drawbacks of the prior art, and in particular a method for crushing an electrochemical generator that can be easily industrialised, without the need for high temperatures, very low temperatures and/or a controlled atmosphere.

This is achieved by a method for crushing an electrochemical generator comprising a negative electrode containing lithium or sodium and a positive electrode, the method comprising a step wherein the electrochemical generator is crushed in an ionic liquid solution containing an ionic liquid and a so-called oxidising redox species that can be reduced at the negative electrode so as to discharge the electrochemical generator.

The invention differs fundamentally from the prior art in that the electrochemical generator is crushed in the presence of an ionic liquid solution containing an ionic liquid and a redox species.

The crushing method opens up the battery and provides access to the lithium or sodium. The ionic liquid solution makes the electrochemical generator safe to open and allows a reactive redox species to be introduced, which discharges the electrochemical generator by oxidation-reduction with the lithium (or the sodium) simultaneously with the crushing thereof.

The absence of water prevents hydrogen, oxygen and/or heat from being generated, which can create explosive atmospheres.

In the description hereinbelow, when lithium is described, this lithium can be replaced by sodium.

According to a first example, in the case of a lithium-metal accumulator, the reduction reaction of the so-called oxidising redox species leads to the oxidation of the lithium metal in ionic form.

According to another example, in the case of a lithium-ion accumulator, the reduction reaction of the so-called reducing redox species leads to the de-insertion of the lithium ion from the active material of the negative electrode.

The free ions extracted from the anode migrate through the ion-conducting electrolyte and are immobilised in the cathode where they form a thermodynamically stable lithium oxide. Thermodynamically stable is understood to mean that the oxide does not react violently with water and/or air.

With the crushing method according to the invention, the lithium is quickly extracted from the negative electrode (anode) while preventing any risk of ignition and/or explosion.

Advantageously, the solution contains a second so-called reducing redox species capable of being oxidised at the positive electrode, the so-called oxidising redox species and the so-called reducing redox species forming a redox species couple.

A redox couple, also referred to as a redox mediator, electrochemical shuttle or redox shuttle, is understood to mean an oxidising/reducing (Ox/Red) couple in solution form, where the oxidising agent can be reduced at the anode (negative electrode) and the reducing agent can be oxidised at the cathode (positive electrode). The redox couple produces the redox reactions and thus discharges the generator, such that the medium remains intact and no reagent is consumed.

The one or more redox species allow the electrochemical generator to be significantly or even completely discharged while reducing the chemical energy of the electrodes, and thus the potential difference between the electrodes (anode and cathode). This discharge also decreases the internal short circuit effect.

The method is cost-effective since the redox couple in solution form simultaneously produces the redox reactions at the electrodes of the electrochemical generator, such that the reagent consumption is zero; the solution can be used to successively make safe a plurality of electrochemical generators.

Advantageously, the redox species couple is a metal couple, preferably chosen from Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺, an organic molecule couple, a metallocene couple such as Fc/Fc⁺, or a halogenated molecule couple, for example Cl₂/Cl⁻ or Cl⁻/Cl³⁻.

Advantageously, the ionic liquid solution contains an additional ionic liquid.

Advantageously, the ionic liquid solution forms a deep eutectic solvent.

Advantageously, the electrochemical generator is immersed in the ionic liquid solution.

Advantageously, the electrochemical generator is discharged at a temperature ranging from 0° C. to 100° C., and preferably from 15° C. to 60° C.

Advantageously, the electrochemical generator is discharged in air.

Advantageously, the method comprises, prior to the step of discharging the electrochemical generator, a dismantling step and/or a sorting step.

Advantageously, the method comprises, subsequent to the step of discharging the electrochemical generator, a pyrometallurgical and/or hydrometallurgical step.

The crushing method according to the invention has numerous advantages:

the generator is made safe (discharged) and opened in a single step, which saves a significant amount of time and investment,

no wet crushing step is implemented, which avoids problems associated with managing hydrogen, oxygen and heat, and thus managing explosive atmospheres (safety, treatment of influents, additional economic cost), and which avoids the need to use large volumes of water and to treat aqueous effluents;

no heat treatment process is implemented, which avoids problems associated with gas emissions (for example the emission of greenhouse gases or any other gases that are harmful and dangerous to humans and the environment), in particular with regard to the treatment thereof, and which reduces the financial and energy costs of the method;

the restrictions associated with the use of water are considerably reduced since ionic liquids are non-volatile, non-flammable and chemically stable at temperatures capable of exceeding 200° C. (for example between 200° C. and 400° C.);

there is no need to control the gas atmosphere when opening the batteries, in particular using inert gases, which simplifies the method and makes it more cost-effective,

the lithium can be accessed directly, which ensures that the generator is discharged extremely quickly, in contrast to prior art methods wherein the discharge step takes several hours or even several days,

a single redox species is used: there is no need to use a redox couple, which broadens the choice and nature of the available species since the species simply has to have a higher electrochemical potential than lithium, while lithium is the species with the lowest electrochemical potential. The lithium can thus be extracted by any species capable of being reduced to a potential greater than −3.05 V vs SHE.

damaged generators, generators that are not discharged or insufficiently discharged and/or generators that cannot be discharged (because their terminals are degraded and/or corroded) are treated without creating safety issues when they are being opened.

Opening by crushing prevents any dependence on the state of damage to the generator. The use of crushing in a waterless and airless environment overcomes this type of issue.

there is no need to control the gas atmosphere when opening the batteries, in particular using inert gases, which simplifies the method and makes it more cost-effective,

it is quick and easy to implement.

Other features and advantages of the invention will appear upon reading the additional description given hereinbelow.

It goes without saying that this additional description is provided solely for the purpose of illustrating the object of the invention and must not be interpreted as constituting a limitation thereto in any way.

### BRIEF DESCRIPTION OF THE FIGURES

The present invention will be better understood after reading the following description of example embodiments, given for purposes of illustration only and not intended to limit the scope of the invention, with reference to the accompanying drawings, wherein:

FIG. 1 diagrammatically shows a sectional view of an electrochemical generator according to one specific embodiment of the invention,

FIG. 2 diagrammatically shows a sectional view of an electrochemical generator according to one specific embodiment of the method of the invention.

The different parts shown in the figures are not necessarily displayed according to a uniform scale in order to make the figures easier to read.

The different possibilities (alternatives and embodiments) must be understood as not being exclusive with regard to one another and can be combined with one another.

### DETAILED DESCRIPTION OF SPECIFIC EMBODIMENTS

Hereinafter, even if the description refers to a Li-ion accumulator, the invention is transposable to any electrochemical generator, for example to a battery comprising a plurality of accumulators (also referred to as battery packs), connected in series or in parallel, depending on the nominal operating voltage and/or the amount of energy to be supplied, or to a battery cell.

These different electrochemical devices can be of the metal-ion type, for example lithium-ion or sodium-ion, or of the Li-metal type, etc.

It can also be a primary system such as Li/MnO₂, or a redox flow battery.

An electrochemical generator with a potential greater than 1.5 V is advantageously chosen.

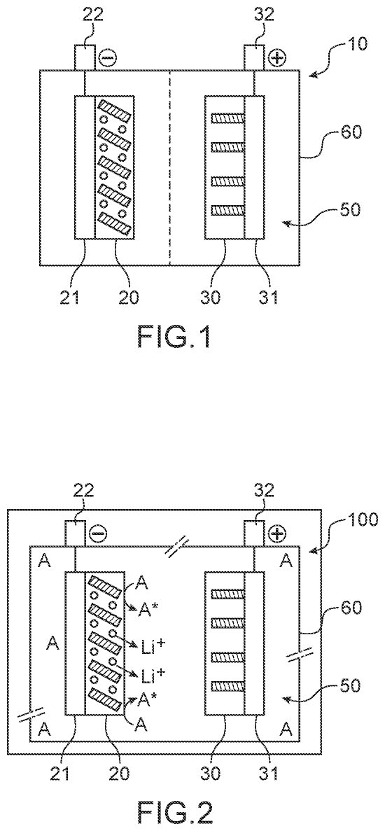

Reference is firstly made to FIG. 1, which shows a lithium-ion (or Li-ion) accumulator 10. A single electrochemical cell is shown, however the generator can comprise a plurality of electrochemical cells, each cell comprising a first electrode 20, in this case the anode, and a second electrode 30, in this case the cathode, a separator 40 and an electrolyte 50. According to another embodiment, the first electrode 20 and the second electrode 30 could be inverted.

The anode (negative electrode) 20 is preferably carbon-based, for example, made of graphite that can be mixed with a PVDF-type binder and deposited on a copper foil. It can also be a lithium mixed oxide such as lithium titanate Li₄Ti₅O₁₂ (LTO) for a Li-ion accumulator or a sodium mixed oxide such as sodium titanate for a Na-ion accumulator. It could also be a lithium alloy or a sodium alloy depending on the technology chosen.

The cathode (positive electrode) 30 is a lithium-ion insert material for a Li-ion accumulator. This can be a lamellar oxide of the LiMO₂ type, a LiMPO₄ phosphate with an olivine structure or a LiMn₂O₄ spinel compound. M represents a transition metal. For example, a positive electrode made of LiCoO₂, LiMnO₂, LiNiO₂, Li₃NiMnCoO₆, or LiFePO₄ is chosen.

The cathode (positive electrode) 30 is a sodium-ion insert material for a Na-ion accumulator. This can be a sodium oxide type material containing at least one transition metal element, a sodium phosphate or sulphate type material containing at least one transition metal element, a sodium fluoride type material, or a sulphide type material containing at least one transition metal element.

The insert material can be mixed with a polyvinylidene fluoride type binder and deposited on an aluminium foil.

The electrolyte 50 contains lithium salts (for example LiPF₆, LiBF₄, LiClO₄) or sodium salts (for example N₃Na), depending on the accumulator technology chosen, solubilised in a non-aqueous solvent mixture. The solvent mixture is, for example, a binary or ternary mixture. The solvents are, for example, chosen from cyclic carbonate-based solvents (ethylene carbonate, propylene carbonate, butylene carbonate), linear or branched carbonate-based solvents (dimethyl carbonate, diethyl carbonate, ethyl methyl carbonate, dimethoxyethane) in various proportions.

Alternatively, it could also be a polymer electrolyte containing a polymer matrix, made of organic and/or inorganic material, a liquid mixture containing one or more metal salts, and optionally a mechanical reinforcing material. The polymer matrix can contain one or more polymer materials, for example chosen from polyvinylidene fluoride (PVDF), polyacrylonitrile (PAN), polyvinylidene fluoride-hexafluoropropylene (PVDF-HFP) or a poly(ionic liquid) of the type poly(N-vinylimidazolium)bis(trifluoromethanesulfonylamide)), N,N-diethyl-N-(2-methoxyethyl)-N-methylammonium bis(trifluoromethylsulfonyl)imide (DEMM-TFSI).

The cell can be wound about itself around a winding axis or have a stacked architecture.

A casing 60, for example a polymer pouch, or a metal packaging, for example made of steel, is used to seal the accumulator.

Each electrode 20, 30 is connected to a current collector 21, 31 passing through the casing 60 and forming, outside the casing 60, the terminals 22, 32 respectively (also referred to as output terminals or electrical terminals or poles). The collectors 21, 31 have two functions: to provide mechanical support for the active material as well as electrical conduction to the terminals of the cell. The terminals (also referred to as electrical terminals or poles) form the output terminals and are intended to be connected to a “power receiver”.

According to some configurations, one of the terminals 22, 32 (for example that connected to the negative electrode) can be connected to the ground of the electrochemical generator. The ground is then said to be the negative potential of the electrochemical generator and the positive terminal is the positive potential of the electrochemical generator. The positive potential is thus defined as the positive pole/terminal as well as all metal parts connected by electrical continuity from this pole.

An intermediate electronic device can optionally be disposed between the terminal that is connected to the ground and the ground.

The electrochemical generator is crushed in the presence of an ionic liquid solution 100 (also referred to as a solution of ionic liquid) containing an ionic liquid and a redox species capable of reacting with the lithium so as to neutralise it, in order to make the electrochemical generator safe.

This ionic liquid solution 100 simultaneously prevents contact between the waste (battery cells or accumulators)/water/air and ensures the discharging of the waste via the electrochemical redox species present in the ionic liquid. The whole process is thus made safe as regards the fire triangle.

Preferably, the electrochemical generator 10 is completely discharged. The free ions are immobilised in the cathode 30, where they form a thermodynamically stable lithium metal oxide that does not react violently with water or air. This takes place at a low environmental and economic cost. Moreover, the treatment does not hinder recycling (and in particular the electrolyte does not decompose). The discharge time will be estimated according to the type of battery cells and accumulators and the charge rate.

The electrochemical generator 10 is at least partially covered by the ionic liquid solution. Preferably, it is completely immersed in the ionic liquid solution 100 (FIG. 2).

The ionic liquid solution 100 contains at least one ionic liquid LI₁, referred to as a solvent ionic liquid, and a redox-active species A.

An ionic liquid is understood to mean the association of at least one cation and one anion that generates a liquid with a melting temperature of less than or about 100° C. These are molten salts.

A solvent ionic liquid is understood to mean an ionic liquid that is thermally and electrochemically stable, minimising decomposition of the medium during the discharge phenomenon.

The ionic liquid solution can further contain one or more (for example two or three) additional ionic liquids, i.e. it contains a mixture of several ionic liquids.

An additional ionic liquid, given the reference LI₂, is understood to mean an ionic liquid that enhances one or more properties with respect to the making safe and discharge step. In particular, this can concern one or more of the following properties: extinction, flame retardant, redox shuttle, salt stabiliser, viscosity, solubility, hydrophobicity, and conductivity.

Advantageously, the ionic liquid, and optionally the additional ionic liquids, are liquid at ambient temperature (20 to 25° C.).

For the solvent ionic liquid and for the one or more additional ionic liquids, the cation is preferably chosen from the family: imidazolium, pyrrolidinium, ammonium, piperidinium and phosphonium.

Advantageously, a cation with a wide cationic window, large enough to envisage a cathodic reaction that prevents or minimises decomposition of the ionic liquid, is preferably chosen.

Advantageously LI₁ and LI₂ will have the same cation to increase the solubility of LI₂ in LI₁. Among the many possible systems, a low-cost, low environmental impact (biodegradability), and non-toxic medium is preferred.

Advantageously, anions are used to simultaneously provide a wide electrochemical window, moderate viscosity, a low melting temperature (liquid at ambient temperature) and good solubility with the ionic liquid and the other species in the solution, and which does not lead to hydrolysis (decomposition) of the ionic liquid.

The TFSI anion is one example that meets the aforementioned criteria for numerous associations with, for example, LI₁: [BMIM][TFSI], or the use of an ionic liquid of the type [P66614][TFSI], the ionic liquid 1-ethyl-2,3-trimethyleneimidazolium bis(trifluoromethane sulfonyl)imide ([ETMIm][TFSI]), the ionic liquid N,N-diethyl-N-methyl-N-2-methoxyethyl ammonium bis(trifluoromethylsulfonyl)amide [DEME][TFSA], the ionic liquid N-methyl-N-butylpyrrolidinium bis(trifluoromethylsufonyl)imide ([PYR14][TFSI]), or the ionic liquid N-methyl-N-propylpiperidinium bis(trifluoromethanesulfonyl)imide (PP13-TFSI). The anion can also be of the type bis(fluorosulfonyl)imide (FSA or FSI), such as the ionic liquid N-methyl-N-propylpyrrolidinium FSI (P13-FSI), N-methyl-N-propylpiperidinium FSI (PP13-FSI), or 1-ethyl-3-methylimidazolium FSI (EMI-FSI), etc.

The anion of the solvent ionic liquid LI₁ and/or of the additional liquid LI₂ can be a complexing anion to form a complex with the electrochemical shuttle.

Other associations are possible, with ionic liquids in which the cation is associated with an anion which can be organic or inorganic, preferably with a wide anodic window.

The ionic liquid solution 100 advantageously forms a deep eutectic solvent (or DES). This is a liquid mixture at ambient temperature obtained by forming a eutectic mixture of 2 salts, of the general formula:

[Cat]⁺·[X]⁻Z[Y]

where:

[Cat]⁺ is the cation of the solvent ionic liquid (for example ammonium),

[X]⁻ is the halide anion (for example Cl⁻),

[Y] is a Lewis or Brönsted acid which can be complexed with the X⁻ anion of the solvent ionic liquid, and

z is the number of molecules Y.

The eutectics can be divided into three categories according to the nature of Y.

The first category corresponds to a type I eutectic:

Y=MClₓ where, for example, M=Fe, Zn, Sn, Fe, Al, Ga

The first category corresponds to a type II eutectic:

Y=MClx.yH₂O where, for example, M=Cr, Co, Cu, Ni, Fe

The first category corresponds to a type III eutectic:

Y═RZ where, for example, Z═CONH₂, COOH, OH.

For example, the DES is choline chloride in association with a very low toxicity H-bond donor, such as glycerol or urea, which guarantees a non-toxic and very low-cost DES.

According to another example embodiment, choline chloride can be replaced by betaine. Although these systems have a limited electrochemical stability window, they can guarantee the flooding and deactivation of an optionally open accumulator.

Advantageously, a compound “Y” that can act as an electrochemical shuttle, which can be oxidised and/or reduced, is chosen. For example, Y is a metal salt, which can be dissolved in the ionic liquid solution to form metal ions. For example, Y contains iron.

By way of illustration, a eutectic can be formed between a chloride anion ionic liquid and metal salts FeCl₂ and FeCl₃ at different proportions and with different cations.

This type of reaction can also be carried out with type II eutectics, which incorporate water molecules into the metal salts; when the water content is low, this does not create a hazard. Low is typically understood to mean less than 10 wt % of the solution, for example 5 to 10 wt % of the solution.

Type III eutectics can also be used, which combine the ionic liquid and hydrogen bond donor species (Y), with a mixture of the type [LI₁]/[Y] where LI₁ can be a quaternary ammonium and Y can be a complexing molecule (hydrogen bond donor) such as urea, ethylene glycol, or thiourea, etc.

A mixture can also be made which will advantageously modify the properties of the solution for discharging the medium. In particular, a solvent ionic liquid of the type [BMIM][NTF₂] which is very stable and liquid at ambient temperature, but which solubilises the electrochemical shuttle (or redox mediator) to a small extent, such as an iron chloride, can be combined.

For example, an additional ionic liquid LI₂ of the type [BMIM][Cl] can be combined, which will enhance the solubilisation of a metal salt in the form of a chloride by complexation with the anion of LI₂. This simultaneously allows for good transport properties and good solubility of the redox mediator, thus enhancing the discharge phenomenon.

The solution 100 contains a redox species. This is an ion or a species in solution form that can be oxidised at the negative electrode according to A→A* where A* is the oxidised form of the species A (FIG. 2). The redox species allows the accumulator to be made safe by extracting the lithium from the negative electrode.

The proposed method makes the accumulator non-reactive to air.

An electrochemical couple or a combination thereof can also be used. Preferably, this is a redox couple acting as an electrochemical shuttle (or redox mediator) to reduce decomposition of the medium, by carrying out redox reactions.

A redox couple is understood to mean an oxidising agent and a reducing agent in solution form, capable of being reduced and oxidised, respectively, at the electrodes of the battery cells. The oxidation/reduction thereof can, advantageously, allow the redox species initially present in solution form to be regenerated. The use of an electrochemical shuttle allows the device to be operated in a closed loop and reduces decomposition of the medium.

The oxidising agent and the reducing agent can be introduced in equimolar or non-equimolar proportions.

One of the redox species can originate from the generator itself. This can in particular be cobalt, nickel and/or manganese.

The redox couple can be an electrochemical metal couple or a combination thereof: Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺.

The redox species and the redox couple can also be chosen from organic molecules, and in particular from: 2,4,6-tri-t-butylphenoxyl, nitronyl nitroxide/2,2,6,6-tetramethyl-1-piperidinyloxy (TEMPO), tetracyanoethylene, tetramethylphenylenediamine, dihydrophenazine, aromatic molecules for example with a methoxy group, an N,N-dimethylamino group such as methoxybenzene anisole, dimethoxybenzene, or an N,N-dimethylaniline group such as N,N-dimethylaminobenzene. Other examples include 10-methyl-phenothiazine (MPT), 2,5-di-tert-butyl-1,4-dimethoxybenzene (DDB) and 2-(pentafluorophenyl)-tetrafluoro-1,3,2-benzodioxaborole (PFPTFBDB).

This can also be from the family of metallocenes (Fc/Fc+, Fe(bpy)₃(ClO₄)₂ and Fe(phen)₃(ClO₄)₂ and its derivatives) or from the family of halogenated molecules (Cl₂/Cl⁻, Cl⁻/Cl³⁻ Br₂/Br⁻, I₂/I⁻, I⁻/I₃⁻).

In particular, a bromide or a chloride is chosen. Preferably this is a chloride that can easily complex metals. For example, iron, complexed by the chloride anion, forms FeCl₄, which can decrease the reactivity of the negative electrode.

This can also be tetramethylphenylenediamine.

A plurality of redox couples can also be combined, wherein the metals of the metal ions are the same or different.

For example, Fe²⁺/Fe³⁺ and/or Cu⁺/Cu²⁺ are chosen. The latter are soluble in their two oxidation states, are non-toxic and do not decompose the ionic liquid.

The solution can contain an extinguishing agent and/or a flame retardant to prevent thermal runaway, in particular in the event of opening the accumulator. This can be an alkyl phosphate, optionally fluorinated (fluorinated alkyl phosphate), such as trimethyl phosphate, triethyl phosphate, or tris(2,2,2-trifluoroethyl) phosphate.) The concentration of active species can be from 80 wt % to 5 wt %, preferably from 30 wt % to 10 wt %.

Optionally, the ionic liquid solution can contain a desiccant, and/or an agent enhancing the transport of material, and/or a protective agent which is a stabiliser/reducer of corrosive and toxic species, for example chosen from PF₅, HF and POF₃.

The agent enhancing the transport of material is, for example, a fraction of a co-solvent that can be added to reduce viscosity.

It can be a small proportion of water, such as 5% water.

Preferably, an organic solvent is chosen for effective action without creating discharge or flammability risks. This can be vinylene carbonate (VC), gamma-butyrolactone (γ-BL), propylene carbonate (PC), poly(ethylene glycol), or dimethyl ether.

The concentration of the agent enhancing the transport of material is advantageously from 1 wt % to 40 wt % and more advantageously from 10 wt % to 40 wt %.

The protective agent capable of reducing and/or stabilising corrosive and/or toxic elements is, for example, a compound of the butylamine type, a carbodiimide (of the type N,N-dicyclohexylcarbodiimide), N,N-diethylamino trimethyl-silane, tris(2,2,2-trifluoroethyl) phosphite (TTFP), an amine-based compound such as 1-methyl-2-pyrrolidinone, a fluorinated carbamate or hexamethyl-phosphoramide. It can also be a compound of the cyclophosphazene family such as hexamethoxycyclotriphosphazene.

Advantageously, the ionic liquid solution contains less than 10 wt % of water, preferably less than 5 wt %.

Even more preferably, the ionic liquid solution is devoid of water.

The method can be carried out at temperatures ranging from 0° C. to 100° C., preferably from 20° C. to 60° C. and even more preferably it is carried out at ambient temperature (20-25° C.).

The method can be carried out in air, or in an inert atmosphere, for example argon, carbon dioxide, nitrogen or a mixture thereof. It can also be carried out in an atmosphere with a controlled oxygen content.

In the case where the electrochemical generator is immersed in the ionic solution, the solution can be stirred to improve the reagent intake. For example, this can involve stirring at between 50 and 2,000 rpm, and preferably between 200 and 800 rpm.

By way of illustration, the crushing step is carried out in a recycling process which can comprise the following steps: sorting, dismantling, crushing and then recycling the elements to be recovered (for example by pyrometallurgy, hydrometallurgy, etc.).

The generator is safely opened to access the recoverable fractions thereof.

### Illustrative and Non-Limiting Example of an Embodiment

In this example, discharge takes place in a glyceline-type medium (a mixture of choline chloride and glycerol).

The ionic liquid solution is an ionic liquid mixture containing choline chloride and glycerol with a volume ratio of 1:2 and a Cp of 2.2 J·g⁻¹·K⁻¹, with 5 wt % of trimethyl phosphate as an extinguishing agent. After the solution has dried, the crushing area of a sealed knife mill is filled with the solution. An 18650 Li-ion type battery cell is then injected into the mill at ambient temperature. Rotation takes place at 50 rpm. The crushing method simultaneously opens the battery cell and allows the reaction between the lithium and the bath to take place, thus discharging and making the battery cell safe.

What is claimed is:

1.-10. (canceled)

11. A method for crushing an electrochemical generator comprising a negative electrode containing lithium or sodium and a positive electrode, the method comprising a step wherein the electrochemical generator is crushed in an ionic liquid solution containing an ionic liquid and a so-called oxidising redox species that can be reduced at the negative electrode so as to discharge the electrochemical generator.

12. The method according to claim 11, wherein the ionic liquid solution contains a second so-called reducing redox species capable of being oxidised at the positive electrode, the so-called oxidising redox species and the so-called reducing redox species forming a redox species couple.

13. The method according to claim 11, wherein the redox species couple is a metal couple, an organic molecule couple, a metallocene couple or a halogenated molecule couple.

14. The method according to claim 13, wherein the redox species couple is a metal couple selected from the group consisting of Mn²⁺/Mn³⁺, CO²⁺/CO³⁺, Cr²⁺/Cr³⁺, Cr³⁺/Cr⁶⁺, V²⁺/N³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺.

15. The method according to claim 13, wherein the redox species couple is Fc/Fc⁺.

16. The method according to claim 13, wherein the redox species couple is a halogenated molecule couple selected from the group consisting of Cl₂/Cl⁻ or Cl⁻/Cl³⁻.

17. The method according to claim 11, wherein the ionic liquid solution contains an additional ionic liquid.

18. The method according to claim 11, wherein the ionic liquid solution forms a deep eutectic solvent.

19. The method according to claim 11, wherein the electrochemical generator is crushed in an inert atmosphere.

20. The method according to claim 11, wherein it comprises, prior to the step of crushing the electrochemical generator, a dismantling step or a sorting step.

21. The method according to claim 11, wherein it comprises, subsequent to the step of crushing the electrochemical generator, a pyrometallurgical or hydrometallurgical step.

22. The method according to claim 11, wherein the electrochemical generator is a lithium-ion generator or a sodium-ion generator.

23. The method according to claim 11, wherein the method is carried out at a temperature ranging from 0° C. to 100° C.
